(19) United States
(12) Patent Application Publication
(10) Pub. No.: US 2008/0300894 A1
(43) Pub. Date: Dec. 4, 2008

(54) Television Audience Targeting Online

(76) Inventor: George H. John, Redwood City, CA (US)

Correspondence Address: STATTLER - SUH PC, 60 SOUTH MARKET STREET, SUITE 480, SAN JOSE, CA, 95113, US

(21) Appl. No.: 11/757,288

(22) Filed: Jun. 1, 2007

(51) Int. Cl. G06Q 30/00

(52) U.S. Cl. 705/1

(57) ABSTRACT

A method of targeting users receives a data feed that has information relating to a first media and extracts events from the received data feed. The method generates a profile relating to a first item in the first media, and processes behavior of a first group of users of a second media. The method models the behavior of the first group of users, and generates a scoring function by using the modeling. A system for targeting a user includes a data feed, an event extractor, one or more profiles, a behavior processor, and a model. The data feed has information relating to a first media. The event extractor is for receiving the data feed and extracting particular information based on a second media. The profile(s) are based on the extracted information. The behavior processor is for receiving the profile and comparing the profile to a first group of users of the second media. The model space is for receiving an output of the behavior processor and modeling user behavior by using the profile.

### FIELD OF THE INVENTION

The present invention is directed towards the field of targeting, and more particularly toward television audience targeting online.

### BACKGROUND OF THE INVENTION

The Internet provides a mechanism for merchants to offer a vast amount of products and services to consumers. Internet portals provide users an entrance and guide into the vast resources of the Internet. Typically, an Internet portal provides a range of search, email, news, shopping, chat, maps, finance, entertainment, and other Internet services and content. Yahoo, the assignee of the present invention, is an example of such an Internet portal.

When a user visits certain locations on the Internet (e.g., web sites), including an Internet portal, the user enters information in the form of online activity. This information may be recorded and analyzed to determine behavioral patterns and interests of the user. In turn, these behavioral patterns and interests may be used to target the user to provide a more meaningful and rich experience on the Internet, such as by using an Internet portal site. For example, if interests in certain products and services of the user are determined, advertisements, pertaining to those products and services, may be served to the user. A behavior targeting system that serves advertisements benefits both the advertiser, who provides their message to a target audience, and a user that receives advertisements in areas of interest to the user.

Currently, advertising through computer networks such as the Internet is widely used along with advertising through other mediums, such as television, radio, or print. In particular, online advertising through the Internet provides a mechanism for merchants to offer advertisements for a vast amount of products and services to online users. In terms of marketing strategy, different online advertisements have different objectives depending on the user toward whom an advertisement is targeted.

Often, an advertiser will carry out an advertising campaign where a series of one or more advertisements are continually distributed over the Internet over a predetermined period of time. Advertisements in an advertising campaign are typically branding advertisements but may also include direct response or purchasing advertisements.

Advertisers typically spend billions even for advertising spots on television that last for just seconds. These relatively short advertising spot purchases are designed to reach a large audience with demographics or attitudes that fit the advertiser's brand. Further, advertisers spend millions on agency fees and media planning to identify which shows they should sponsor. However, this investment is generally not designed to be leveraged effectively in conjunction with directing online spending. Moreover, conventionally, it is not easy to target a given show's audience online.

### SUMMARY OF THE INVENTION

A method of targeting users receives a data feed that has information relating to a first media and extracts events from the received data feed. The method generates a profile relating to a first item in the first media, and processes behavior of a first group of users of a second media. The method models the behavior of the first group of users, and generates a scoring function by using the modeling.

Generally, when the first media involves television programming, the data feed includes information relating to a television broadcast. In these cases, the method selects a particular television broadcast, and extracts events relating to the selected television broadcast. When the second media involves online media, the generated profile includes a list of relevant online activities. Preferably, while processing behaviors, the method tracks for the first group of users, activities relating to the second media, and compiles the tracking for each user by using a unique identifier. The modeling is often a batch process for the first group of users.

The scoring function is for measuring an interest of a user of the second media in an item within the first media, and the method scores a second group of users of the second media by using the scoring function. The scoring is often advantageously performed in real time, as users and new users interact with the second media. In some embodiments, a user is selected based on the scoring. The selected user has a likelihood of interest in the first item in the first media. Hence, some of these embodiments target the selected user by using a cobranded creative. In this way, content that is relevant to both the first media and the selected user, is determined and/or generated within the second media for presentation to the selected user within the second media.

A system for targeting a user includes a data feed, an event extractor, one or more profiles, a behavior processor, and a model. The data feed has information relating to a first media. The event extractor is for receiving the data feed and extracting particular information based on a second media. The profile(s) are based on the extracted information. The behavior processor is for receiving the profile and comparing the profile to a first group of users of the second media. The model space is for receiving an output of the behavior processor and modeling user behavior by using the profile.

Some embodiments include a scoring function that is based on the modeling. The scoring function is for measuring an interest of a user of the second media for an item within the first media. When the second media is an online type media, some implementations include a crawler such as a web spider for compiling information relating to the second media. Preferably the system includes an administration tool for interfacing with the data feed(s), one or more crawlers or other information gathering means, and the event extractor. The administration tool advantageously provides maintenance functionally such as configuration, customization, and/or tuning services, for example.

### BRIEF DESCRIPTION OF THE DRAWINGS

The novel features of the invention are set forth in the appended claims. However, for purpose of explanation, several embodiments of the invention are set forth in the following figures.

FIG. 1 is a chart that illustrates average hours spent with media per week.

FIG. 2 illustrates a modeling process of some embodiments.

FIG. 3 illustrates a scoring process of some embodiments.

FIG. 4 illustrates a system implementation.

FIG. 5 illustrates an additional system implementation.

FIG. 6 illustrates an alternative system implementation in accordance with some embodiments of the invention.

FIG. 7 illustrates a distribution for some types of look alike modeling.

FIG. 8 illustrates an exemplary cobranded creative.

FIG. 9 illustrates another instance of a creative.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order not to obscure the description of the invention with unnecessary detail.

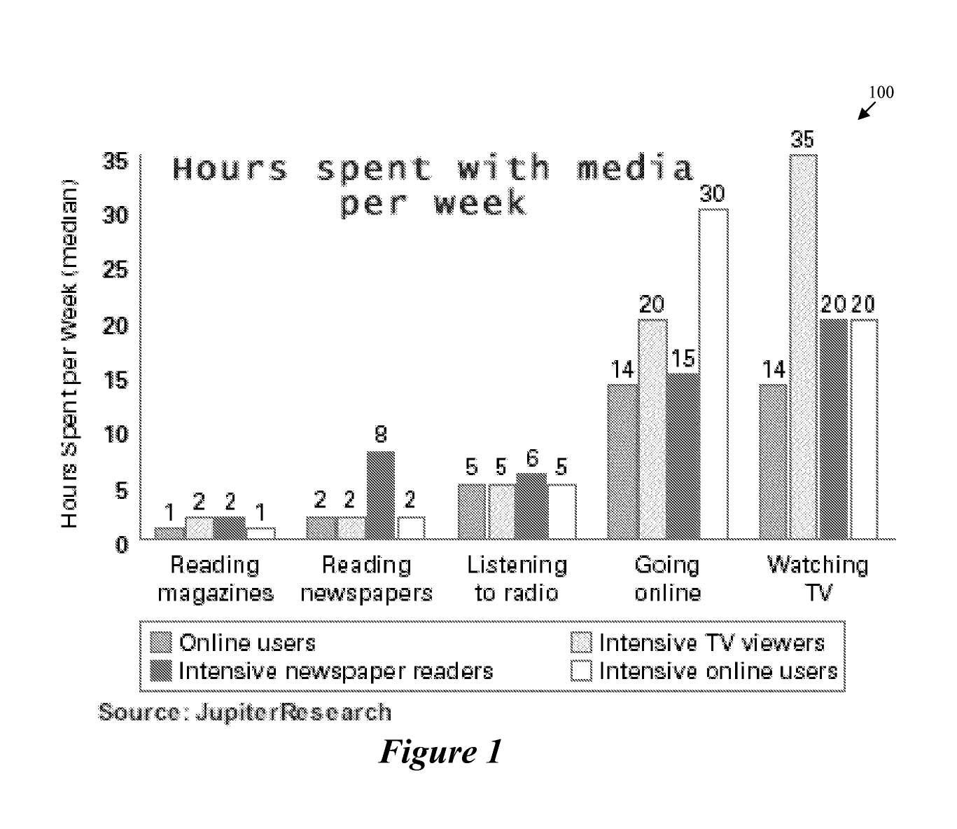

Embodiments of the invention advantageously allow advertisers to leverage investments in advertising directed toward one type of media such as television, for example, to direct advertising expenditures within another type of media, such as online type media. Overall, Internet usage has caught up to television viewing in terms of average time spent. FIG. 1 illustrates graphically the foregoing phenomena. In FIG. 1, the activities of going online, and watching television are illustrated along the x-axis, while the y-axis shows the median hours spent per week by potential consumers within each activity. The data of FIG. 1, are provided by Jupiter Research, Inc. and additional information is available at <http://www.marketingvox.com/archives/2007/03/01/online-tv-viewers-more-devoted-to-shows-sponsors>. Moreover, the general trend is yearly decline in time spent watching television coupled with an increase in time spent online.

In desirable demographics, such as high income areas, for example, the trend is even more pronounced, with significantly more time spent online. This phenomenon motivates advertisers to respond accordingly, whereby such advertisers advantageously treat advertising as a continuum, and target consumer demographics through television media, in conjunction with Internet type media, or another type of media.

By allowing advertisers to purchase online advertising that is directed toward an audience likely to view a particular television program, broadcast, and/or show, advertisers are enabled to target the same audience across media types and smoothly adjust spending as the audience's time spent online versus watching television changes. Further, a given advertiser may run ads on a number of shows and/or channels within the same media.

For example, a company with a branded image such as Apple Inc., for example, advertises during broadcasts of the popular television programs “24” and “The Office”. For television advertising, Apple knows which show the consumer is currently viewing because Apple's advertisement is shown between particular segments of each show. When a user of online media who also watches television is active online, it can be determined that the user watches both shows, but the advertisement may achieve higher response rate by co-branding with a particular show, in which case there is an opportunity to tune the advertising, such as to choose the show that the user would be attracted to the most, for example.

Additionally, the advertising is advantageously tuned even to the accuracy of a character, an episode, and/or a specific event on the show in which the user is most, or more, likely to be interested. Such tuning further improves results for the advertiser, such as by improving advertising efficacy per dollar spent within the combined media, such as television and Internet combined media, for instance. Some embodiments of the invention achieve the foregoing by advantageously employing a specific type of behavioral targeting.

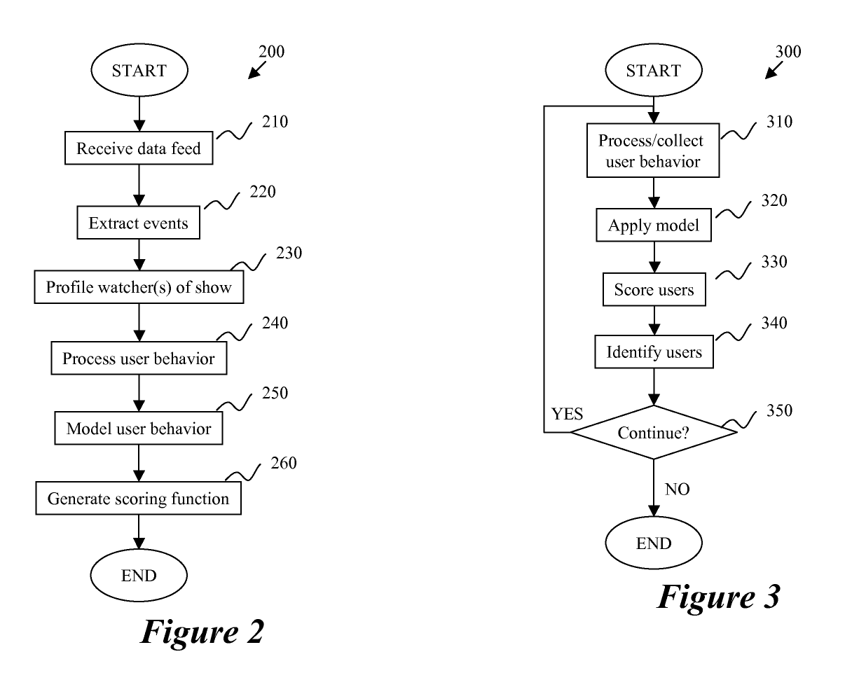

FIG. 2 illustrates a modeling process 200 according to some of these embodiments. As shown in this figure the process 200, begins at the step 210, where one or more data feeds are received. The data feeds are generally relevant to television programming, and more specifically include show and/or episode synopses, and various detailed information relating to characters and events that have significance to the show. Other useful data relating to a show includes geographical and airtime information, audience demographics, typical advertising expenditures, and additional show and broadcast data. These data are useful to aid in selecting popular programs, or programming that has high advertising expenditures, for instance. Moreover, these data include data that are significant to the selected programming, and/or to the viewers or audience of the broadcasts of the programming.

Hence, at the step 220, selected events are extracted from the data feeds. Advantageously, the events that are extracted are based on relevancy data, such as to a group of users in another media, for example. Accordingly, at the step 230, the process 200 profiles a selected show or group of shows. A show profile has relevance to a user or a group of users who exhibit some interest in the selected television show. Preferably, the profiling is automated. To profile a particular television show, some embodiments compile and/or tag a list of activities that indicate interest in the show. For instance, posting to a newsgroup or blogging in relation to the show are relatively strong indicators of interest. One of ordinary skill recognizes many other such activities and/or indicators. Preferably, the generated profile represents a behavioral signature for the activities of watchers of the show. Some embodiments employ two phases to generate the profile or behavioral signature. The first phase typically involves information that has a known relationship to the selected television program, while the second phase involves extending that information to determine new relationships and/or indicators of relevance.

Once one or more shows are profiled at the step 230, the process 200 transitions to the step 240, where processing of user behavior occurs. The processing typically includes collecting users and/or information related to the users. Often the processing involves groups of multiple users, organizing the groups of users, and storing and/or retrieving the groups, and related user information. Preferably, each user has an associated unique identifier such that the behavior of each user is uniquely tracked. When the user media comprises an online media type activity, user behaviors of interest often include searching, posting, and/or blogging. As mentioned above, one of ordinary skill recognizes additional online user behaviors.

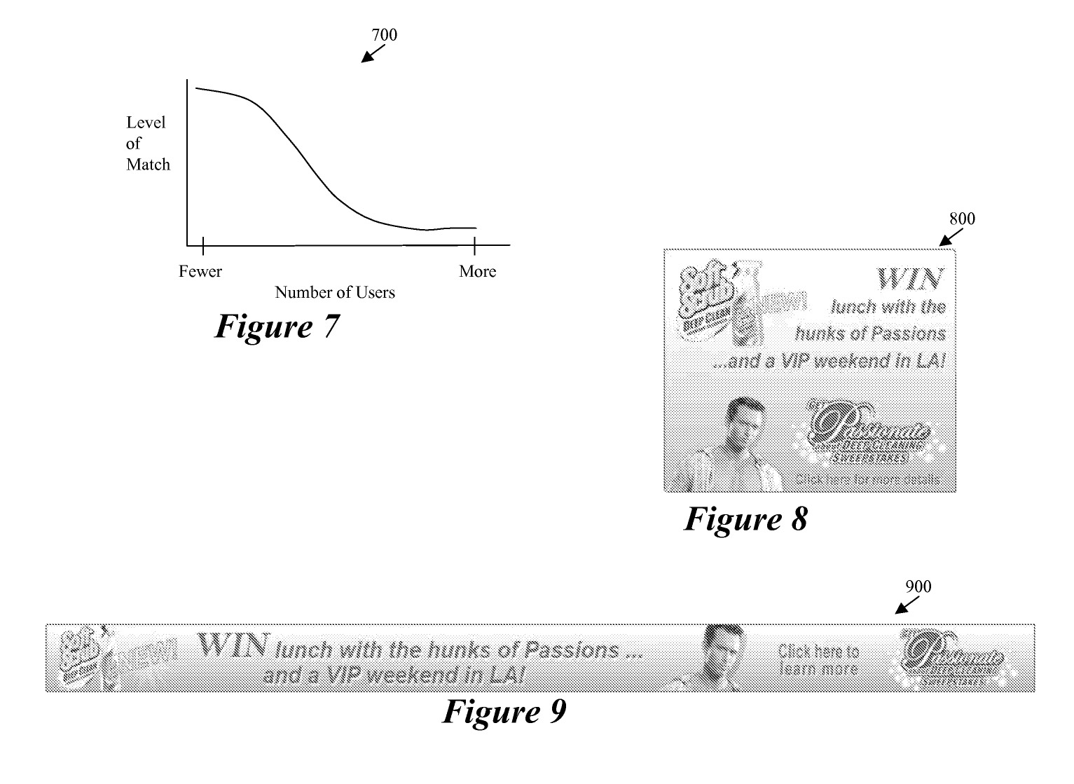

At the step 250, the process 200 compares the behaviors processed for the users at the step 240 with the show watcher profile generated at the step 230. Some embodiments use a large set of users such as a full site audience, and project the users and associated behaviors onto a user-feature-space, thereby identifying particular matches between users and the show watcher profile. Some embodiments further provide for degrees of matching. Preferably, a model of user behavior is generated in relation to the show watcher profile. For instance, a particular implementation uses look-alike modeling of users based on similarity to those users who are known to be interested in a selected television show. FIG. 7 illustrates a sample distribution 700 for some types of look alike modeling that are based on level or degree of match. As shown in FIG. 7, with look alike modeling, a small subset of users sampled are expected to exhibit a higher degree of match relative to the larger group sampled.

At the step 260, the process 200, of FIG. 2, generates a scoring function based on the model employed at the step 250. Advantageously, the scoring function expresses a relationship between a particular user's behavior relating to a second media, and propensity for interest in an item in a first media. In the present example, the scoring function relates online activities to a likelihood of interest in a selected television program, episode, character, and/or show. For instance, a simple scoring function in the present example includes a mathematical function that sums the number of times a particular user visits a blog related to the television program “24,” views pages of “Jack Bauer” and Kiefer Sutherland, a character and actor on the show, and posts online containing similar content. The scoring function is often more complex. For example, some scoring functions include an associated weight with each of these online media type activities, and the product of the weights and frequencies are summed or tabulated in a more complex manner. The weights are often precalculated and preferably are based on strength of relationship to the program. For example, the activities of posting and/or blogging are typically strong indicators of a show watcher, and/or of affinity for the program, episode, character and/or event, which is the subject matter of the post or blog.

After the step 260, the process 200 concludes. However, once generated, the scoring function of the process 200 has a variety of uses such as for use in relation to a scoring process of a group of new or unknown users.

FIG. 3 illustrates a scoring process 300 in accordance with embodiments of the invention. The process 300 begins at the step 310, where user behavior is processed. Preferably, the user behavior is processed at the step 310 in real time and/or on an ongoing basis. Moreover, during user behavior or interaction online, the process 310 collects a variety of users and activities associated with the collected users. Some embodiments track each user activity by using a system of unique identification.

At the step 320, the process 300 applies a model to the collected users and user behaviors collected at the step 310. For instance, at the step 320 the process 300 preferably scores one or more users in the collected or observed set of users to determine each scored user's propensity to exhibit interest in a show. Particular embodiments advantageously employ the model and/or scoring function described above in relation to FIG. 2. For instance, some implementations apply a look-alike model to the collected set of users to match to a set of watchers or a typical watcher of a show. Further, some implementations apply the scoring function to measure the strength of the users' likelihood of interest in the show, and thus, an image or creative co-branded with the show.

Then, by using the information obtained at the steps 320 and 330, a set of target users is identified at the step 340. The identified set of target users preferably has high relevance to the selected television programming. A number of advantageous uses are then applied to this information. For instance, some embodiments undertake smart selection of a co-branded creative to use in an advertisement that is preferably targeted with heightened accuracy toward a specific set of highly relevant users.

Once identification and/or additional targeting is performed at the step 340, the process 300 transitions to the step 350, where a determination is made whether to continue the process 300 such as in a real time, or multiple batch process, for example, or for additional users or groups of users. If the process 300 should continue at the step 350, then the process 310 returns to the step 310, where the process 300 continues processing behaviors and/or collecting users and data. Otherwise, after the step 350, the process 300 concludes.

Once a number of users and associated users scores are collected, alternative embodiments use the data in different ways as part of the process 300, or as part of another process. Some embodiments group the users and present the groups to an advertiser as a behaviorally targeted selection on a rate card, for instance. A particular implementation records geographic and/or temporal data for each user, such as time zone and location information. Such an implementation optionally provides these behaviorally targeted data as a selection for targeted and/or directed content, as well. Also, as described above, some embodiments further select and/or generate a creative for distribution through a second media, by using data based on a first media. FIGS. 8 and 9 illustrate examples 800 and 900 of such creatives. As shown in these figures, users of a distinct media such as online users are advantageously targeted for content distribution based on a likelihood of relevance or affinity for the selected television program “Passions” and viewers thereof. One of ordinary skill further recognizes variations in the embodiments described above. For instance, target group sizes and demographics typically vary. A much smaller target group size is acceptable when the content or brand includes luxury yachts, than when it includes soaps or cleaning products, for example.

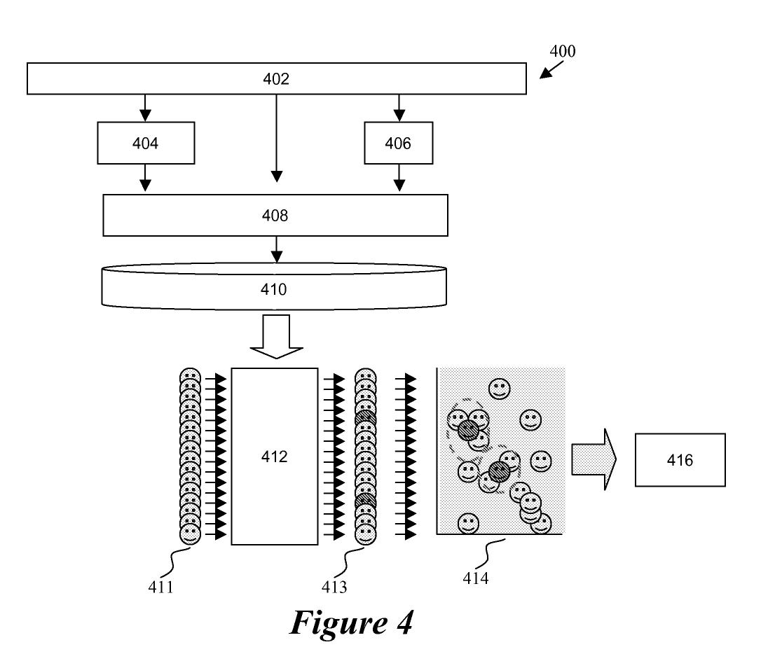

Some embodiments of the invention include a system implementation 400, which is illustrated in FIG. 4. As shown in this figure, the system 400 includes an administration tool 402, one or more data feed(s) 404 and crawler(s) 406, an event extractor 408, one or more profile(s) 410, a behavior processor 412, and a model space 414 that outputs a scoring function 416. As shown in this figure, the administration tool 402 interfaces with the data feeds 404, the crawlers 406, and the event extractor 408 to allow configuration and maintenance of these components, including customization and tuning.

The data feeds 404 typically include a variety of compiled information relating popular television shows. The crawlers 406 are typically web crawlers or spiders that collect and aggregate online data in an automated fashion. The event extractor 408 receives input from the data feeds 404 and crawlers 406 and extracts desirable events or elements that are relevant to both forms of the input data.

Preferably, the input data to the event extractor 408 is from two or more different sources, such as the television media and online media in the present example, or from additional media types. Data compilation in the event extractor 408 from the different sources need not be simultaneous, but is instead optionally stored and/or retrieved, as needed. Further, one of ordinary skill recognizes alternative means of receiving these types of data. For instance, online data need not be crawled if the data is alternatively precompiled by using another means, instead.

Regardless of timing and source, the event extractor 410 identifies and locates high relevance data in the input data from the different media sources. Accordingly, FIG. 4 further illustrates automated construction of a profile that profiles a typical watcher of a television show. Some embodiments employ a list structure for the show profile. Advantageously, the profile is then input to the behavior processor 412, which receives a set of online media users 411 and tags users displaying interest in the show. Preferably, the tagging is by using the constructed profile. In FIG. 4, the tagged users are illustrated as darker than the untagged users.

As described above, the profiling and/or tagging is performed by using a variety of indicative factors. For instance, some embodiments use a behavioral match system that compares activities such as searching on the show's title or actors, such as visiting the show's Internet information page or related links, and/or browsing entertainment news about the show or its actors. These embodiments advantageously employ a modeling scheme such as look-alike modeling to map and/or extend a show's spectator or audience group onto a target set of users of another type of media, such as a set of online or Internet users.

As mentioned above, the users who are tagged by the behavior processor 412 are shown darkened. Once one or more users are tagged by the behavior processor 412, these users are further advantageously used to generate a more empirical model of behavior. As further mentioned, particular embodiments apply look-alike modeling in the model space 414. Preferably, a scoring function 416 is thereby generated such as for real time and/or bulk application, for instance.

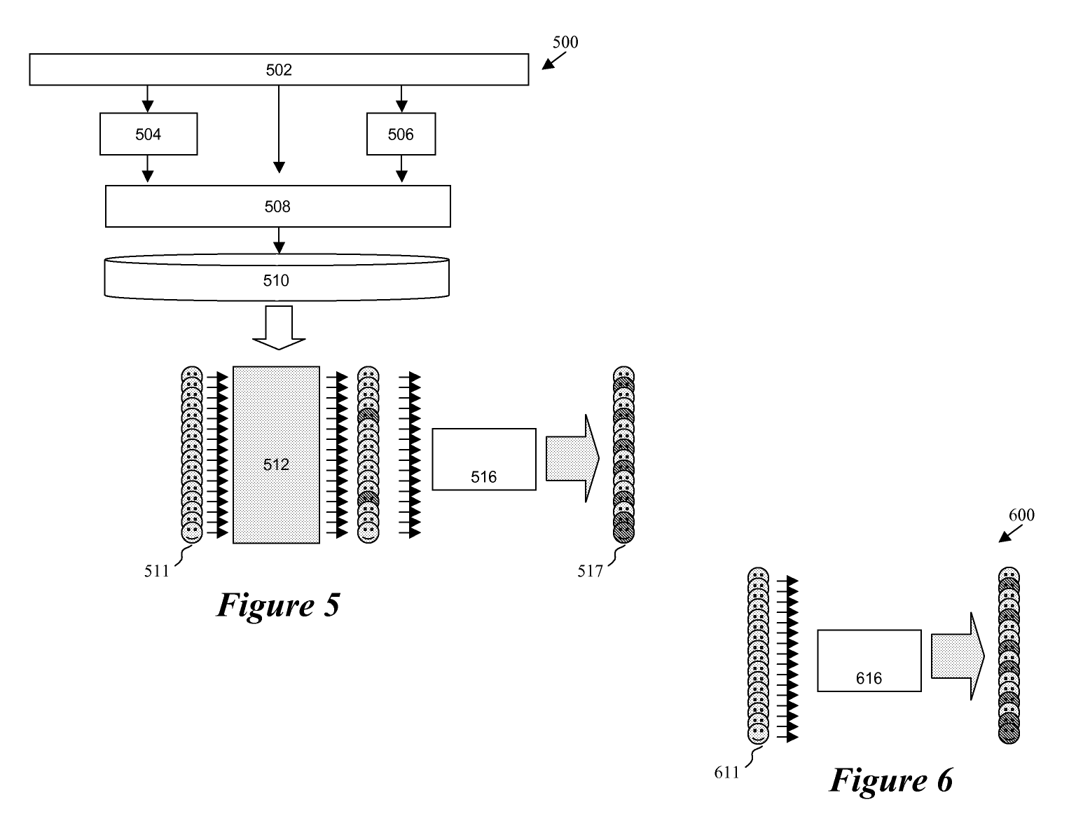

FIG. 5 illustrates such an instance, where the model and/or scoring function of FIG. 4 are used, or reused on a continuous or periodic basis. As shown in FIG. 5, the system 500 includes an event extractor 508 that generates one or more profile(s) 510, as described above. The profiles 510 are input to a behavior processor 512 that applies the profiles 510 to a set of media users, such as online media users 511. However, rather than used to construct a model of behaviors, the processed users are advantageously scored by using the scoring function 516, which as described above, measures the users' likelihood of interest in the selected item within the first media such as, for example, a particular television show, or element thereof. Some embodiments further streamline the process of scoring large numbers of users, on a periodic, batch, and/or real time basis, without the need for additional processing of these users.

FIG. 6 illustrates that once a scoring function 616 is determined, some embodiments 600 optionally apply the scoring function in the absence of other models and/or modeling. These embodiments typically identify a set of more relevant users 613 from a group or multiple groups 611 of users rapidly, which has particular advantages such as for real time deployment. The scoring function 616 of these embodiments is conveniently substituted and/or updated at various times as needed.

Advantages

Some of the embodiments described above are relevant to the field of Behavioral Targeting, which is further described in the U.S. patent application Ser. No. 11/394,343 [Y01410US00, P0003] to Joshua Koran, et al., filed 29 Mar. 2006, which is incorporated herein by reference. Alternatively, or in conjunction with the concepts described in the patent application incorporated by reference above, embodiments of the present invention target audiences across separate media. For instance, a particular embodiment specifically targets a television audience that separately and/or simultaneously engages as users in online media based activity. More specifically, the online users are targeted based on the behavior of such users, for example.

Further, some of the implementations described above advantageously use look alike modeling to identify not only users who have searched on specific television programming, or details of that programming such as a specific character, event, or episode, but also to project users into a feature-space. The feature space allows identification of users who have not performed the exact same activities as other relevant users, but whose behavior otherwise is quite similar to users who have searched on, or are otherwise relevant to, the selected programming.

Moreover, particular embodiments optimize a cobranded creative for a user who may be affiliated with, or who has showed interest in, a number of shows. Accordingly, targeting online users in relation to a television audience offers many benefits. Advantageously, advertisers, who have already made significant investments in researching, studying, and understanding brand affinity and/or demographics, are enabled to smoothly address a highly relevant target audience across a wider spectrum of media. Advertisers further achieve brand goals by displaying brand advertisements to a selected and/or optimized audience. Moreover, advertisers achieve higher performance such as, for example, click-through rate, conversion, and/or other metrics. Such higher performance or efficacy is advantageously achieved by attracting users to an advertisement based on the user's affinity to a particular television show or even, an element relevant to the selected show such as, for example, a character or element associated with the selected show.

The foregoing is advantageously applicable to a variety of automated means and methods of identifying a television audience online. In a more specific example, Microsoft and NBC jointly launch an initiative where viewers are directed to a specialized website such as “apprentice.nbc.com/vote,” where people vote on their favorite candidate for the NBC's popular television show The Apprentice. Some of the embodiments described above preferably “tag” users who visit the website as viewers of the show, which in this case is The Apprentice. Some of these embodiments then use data mining techniques to build a model based on the tagged users. Preferably, the methods described above are used to inflate the constructed model and/or data to capture additional users who exhibit similar patterns on another website and/or or web portal such as MSN, for instance. In these embodiments, specific content is preferably used such as in the form of contests, episode synopses or discussions, and the like, as specific behaviors that are included in forming the tagged and/or seed audience.

While the invention has been described with reference to numerous specific details, one of ordinary skill in the art will recognize that the invention can be embodied in other specific forms without departing from the spirit of the invention. For instance, the examples given above often relate to television and/or online media. However, targeting across a multiple of media types is contemplated as well. Thus, one of ordinary skill in the art would understand that the invention is not to be limited by the foregoing illustrative details, but rather is to be defined by the appended claims.

1. A method of targeting users, the method comprising:
receiving a data feed having information relating to a first media;
extracting events from the received data feed;
generating a profile relating to a first item in the first media;
processing behavior of a first group of users of a second media;
modeling the behavior of the first group of users, the modeling including;
generating a scoring function by using the modeling.

2. The method of claim 1, the data feed comprising information relating to a television broadcast, the method further comprising:
selecting the television broadcast; and
extracting events relating to the selected television broadcast.

3. The method of claim 1, the second media comprising an online media, wherein generating the profile comprises compiling a list of relevant online activities.

4. The method of claim 1, the step of processing behavior further comprising:
tracking for the first group of users activities relating to the second media; and
compiling the tracking by using a unique identifier.

5. The method of claim 1, the modeling comprising a batch process.

6. The method of claim 1, the scoring function for measuring an interest of a user of the second media for an item within the first media, the method further comprising:
scoring a second group of users of the second media by using the scoring function.

7. The method of claim 6, the scoring further comprising a real time process.

8. The method of claim 6, further comprising selecting a user based on the scoring, wherein the selected user has a likelihood of interest in the first item in the first media.

9. The method of claim 8, further comprising targeting the selected user by using a cobranded creative.

10. The method of claim 1, further comprising:
selecting content within the second media for presentation to a selected user within the second media, the content relevant to the first item in the first media; and
providing selections that comprise data based on one or more of behaviorally targeted users, geographic data, and temporal data associated with one or more users.

11. A system for targeting a user, the system comprising:
a data feed having information relating to a first media;
an event extractor for receiving the data feed and extracting particular information based on a second media;
a profile based on the extracted information;
a behavior processor configured for:
receiving the profile,
tracking behavior for a first group of users of the second media, and
comparing the profile to the tracked behavior; and
a model space for receiving an output of the behavior processor, and for modeling the user behavior.

12. The system of claim 11 further comprising a scoring function based on the modeling, the scoring function for measuring an interest of a user of the second media for an item within the first media.

13. The system of claim 11, further comprising a look alike model.

14. The system of claim 11 further comprising a crawler for compiling information relating to the second media.

15. The system of claim 13, wherein the second media comprises an online media, the crawler comprising a network type information gathering spider.

16. The system of claim 11 further comprising an administration tool for interfacing with at least one of: the data feed, one or more crawlers, and the event extractor, the administration tool for providing maintenance functionality comprising one of configuration, customization, and tuning.

17. The system of claim 11, wherein the first media comprises television programming, wherein the extracted information relates to a particular item of television programming.

18. The system of claim 11, wherein the second media comprises online media, wherein the user behavior comprises one or more online activities.

19. A method of targeting, the method comprising:
selecting a first item in a first media, the first item comprising associated data and an audience;
generating a profile comprising a relevance to one or more of the first item, the audience, and a second media;
tracking behaviors of users of the second media;
tagging a first user of the second media, based on a relationship between the first user's tracked behavior and the profile; and
comparing the tagged first user to one or more additional users.

20. The method of claim 19, further comprising constructing a model by using the tracked behavior; and generating a scoring function that measures similarities with the tagged first user.

21. (canceled)

22. The method of claim 21, further comprising scoring a second user, and associating the score with the second user; and selectively targeting the second user within the second media based on the associated score.

23. (canceled)

24. The method of claim 19, wherein the first user and the second user are members of the audience, wherein a behavior of the second user is different than a behavior of the first user.

25. The method of claim 19, the user behavior comprising one or more of, in relation to the first item, searching, posting, and blogging.

26. The method of claim 19, wherein the first media comprises television, the first item comprises a television program, and the audience comprises viewers of the television program,
wherein the second media comprises the Internet, wherein generating the profile comprises using a relevance to one or more of the television program, the viewers of the program, and the Internet, wherein tracking behaviors of users of the Internet comprises tagging a first user of the Internet, based on a relationship between the first user's tracked behavior and the profile.

27. The method of claim 26, wherein the relationship comprises visiting a particular website, wherein the relationship further comprises specific content in the form of one or more of a contest, an episode synopsis, and a discussion regarding the television program, such that specific behaviors regarding the program are included by the tagging.

28. (canceled)
